(19) United States
(12) Patent Application Publication
(10) Pub. No.: US 2017/0244094 A9
(43) Pub. Date: Aug. 24, 2017

(54) COMPOSITE MATERIAL HAVING DOMAINS OF LITHIUM OXOMETALLATES IN A MATRIX

(71) Applicants: Andreas STEIN, Saint Paul, MN (US); Anh Dinh VU, Woodridge, IL (US); Yuan FANG, Minneapolis, MN (US); Benjamin Edwin WILSON, Saint Paul, MN (US); REGENTS OF THE UNIVERSITY OF MINNESOTA, Minneapolis, MN (US)

(72) Inventors: Andreas Stein, Saint Paul, MN (US); Anh Dinh VU, Woodridge, IL (US); Yuan Fang, Minneapolis, MN (US); Benjamin Edwin Wilson, Saint Paul, MN (US)

(21) Appl. No.: 15/121,146

(22) PCT Filed: Feb. 27, 2015
(86) PCT No.: PCT/US2015/018030

§ 371 Date: Aug. 24, 2016

Related U.S. Application Data
(60) Provisional application No. 61/946,180, filed on Feb. 28, 2014.

(51) Int. Cl. H01M 4/131; H01M 4/62; H01M 4/36; H01M 4/1391; H01M 4/04; H01M 10/0525; H01M 4/485

(52) U.S. Cl. CPC H01M 4/131; H01M 10/0525; H01M 4/623; H01M 4/622; H01M 4/625; H01M 4/626; H01M 4/485; H01M 4/1391; H01M 4/0402; H01M 4/362

(57) ABSTRACT

Composite materials having domains of lithium oxometallates in an electronically conductive matrix, and methods of making such composite materials are provided. Exemplary lithiated metals oxides include, for example, doped or undoped lithium oxometallates of the formula Li₈M^{a}O₆ and/or Li₇M^{b}O₆, wherein M^{a} represents Zr and/or Sn, and M^{b} represents Nb and/or Ta. Such composite materials can be used in lithium ion batteries, for example, as an active material such as an electrode that can store charge in the form of lithium ions.

This application claims the benefit of U.S. Provisional Application No. 61/946,180, filed Feb. 28, 2014, which is incorporated herein by reference in its entirety.

### GOVERNMENT SUPPORT

This invention was made with government support under DE-SC0008662 awarded by the Department of Energy. The government has certain rights in the invention.

### BACKGROUND

Lithium ion batteries (LIBs) are the major power source for mobile electronic devices, and are receiving increasing attention for applications in hybrid and electric vehicles. These applications demand LIBs with high capacity, good rate performance, and long cycle life. However, commercialized cathode materials deliver specific capacities lower than 200 mAh/g.

In the 21^{st} century there will continue to be a growing need for additional types of electric power sources. Innovations in transportation and portable devices may result in increasingly high levels of performance in both energy and power densities, as well as lower cost designs and increased safety. To achieve significant performance improvements, new electrode materials and architectures will be needed. However, the specifications for such materials are rigorous, calling for high specific capacities, high voltages, low internal resistance, fast charge and discharge rates, good cyclabilities, efficient heat transfer, low cost, safety, etc. It has proven difficult to discover new materials that concurrently meet all or most of these criteria.

### SUMMARY

In one aspect, the present disclosure provides a composite material. In one embodiment, the composite material has domains of one or more lithium oxometallates in an electronically conductive matrix, wherein the one or more lithium oxometallates are of the formula Li₈M^{a}O₆, Li₇M^{b}O₆, or a doped lithium oxometallate thereof, wherein M^{a} represents Zr and/or Sn, and M^{b} represents Nb and/or Ta. In some embodiments, the domains (e.g., nano-sized domains) of Li₈M^{a}O₆ and/or Li₇M^{b}O₆ include particles (e.g., nanoparticles) and/or sheets (e.g., nanosheets) of Li₈M^{a}O₆ and/or Li₇M^{b}O₆. In certain embodiments, the electronically conductive matrix includes conductive carbon (that in some embodiments can be nanoporous carbon) and/or conductive metallic nanoparticles. In some embodiments, the composite material further includes a polymeric binder.

In one embodiment, the doped lithium oxometallate of the formula Li₈M^{a}O₆ further includes a lithium replacing dopant and is of the formula Li₍₈₋ₙₓ₎DₓM^{a}O₆, wherein M^{a} represents Zr and/or Sn; D represents an optional lithium replacing dopant selected from the group consisting of Mg, Ag, Co, Ni, or a combination thereof; n represents the formal oxidation state of the dopant D; and x=0.00005 to 2.

In another embodiment, the doped lithium oxometallate of the formula Li₈M^{a}O₆ further includes: a Li and M^{a} replacing dopant, wherein the doped lithium oxometallate is of the formula Li₍₈₋ₓ₍ₙ₋₄₎₎EₓM^{a}₍₁₋ₓ₎O₆, wherein M^{a} represents Zr and/or Sn; E represents a Li and M^{a} replacing dopant selected from the group consisting of Ti, Nb, Ce, Mo, Y, Mn, Fe, or a combination thereof; n represents the formal oxidation state of the dopant E; and x=0.00005 to 0.25; an M^{a} and O replacing dopant, wherein the doped lithium oxometallate is of the formula Li₈EₓM^{a}₍₁₋ₓ₎O_{(6-(n-4)x/2)}, wherein M^{a} represents Zr and/or Sn; E represents an M^{a} and O replacing dopant selected from the group consisting of Ti, Nb, Ce, Mo, Y, Mn, Fe, or a combination thereof; n represents the formal oxidation state of the dopant E; and x=0.00005 to 0.25; or a Li, M^{a}, and O replacing dopant, wherein the composition of the doped lithium oxometallate corresponds to a combination of the formulas Li₍₈₋ₓ₍ₙ₋₄₎₎EₓM^{a}₍₁₋ₓ₎O₆ and Li₈EₓM^{a}₍₁₋ₓ₎O_{(6+(n-4)x/2)}, wherein M^{a} represents Zr and/or Sn; E represents a Li, M^{a}, and O replacing dopant selected from the group consisting of Ti, Nb, Ce, Mo, Y, Mn, Fe, or a combination thereof; n represents the formal oxidation state of the dopant E; and x=0.00005 to 0.25.

In another embodiment, the doped lithium oxometallate of the formula Li₇M^{b}O₆ further includes a lithium replacing dopant and is of the formula Li₍₇₋ₙₓ₎DₓM^{b}O₆, wherein M^{b} represents Nb and/or Ta; D represents an optional lithium replacing dopant selected from the group consisting of Mg, Ag, Co, Ni, or a combination thereof; n represents the formal oxidation state of the dopant D; and x=0.00005 to 2.

In another embodiment, the doped lithium oxometallate of the formula Li₇M^{b}O₆ further includes: a Li and M^{b} replacing dopant, wherein the doped lithium oxometallate is of the formula Li₍₇₋ₓ₍ₙ₋₅₎₎EₓM^{b}₍₁₋ₓ₎O₆, wherein M^{b} represents Nb and/or Ta; E represents a Li and M^{b} replacing dopant selected from the group consisting of Ti, Nb, Ce, Mo, Y, Mn, Fe or a combination thereof; n represents the formal oxidation state of the dopant E; and x=0.00005 to 0.25; an M^{b} and O replacing dopant, wherein the doped lithium oxometallate is of the formula Li₇EₓM^{b}₍₁₋ₓ₎O_{(6+(n-5)x/2)}, wherein M^{b} represents Nb and/or Ta; E represents an M^{b} and O replacing dopant selected from the group consisting of Ti, Nb, Ce, Mo, Y, Mn, Fe, or a combination thereof; n represents the formal oxidation state of the dopant E; and x=0.00005 to 0.25; or a Li, M^{b}, and O replacing dopant, wherein the composition of the doped lithium oxometallate corresponds to a combination of the formulas Li₍₇₋ₓ₍ₙ₋₅₎₎EₓM^{b}₍₁₋ₓ₎O₆ and Li₇EₓM^{b}₍₁₋ₓ₎O_{(6+(n-5)x/2)}, wherein M^{b} represents Nb and/or Ta; E represents a Li, M^{b}, and O replacing dopant selected from the group consisting of Ti, Nb, Ce, Mo, Y, Mn, Fe, or a combination thereof; n represents the formal oxidation state of the dopant E; and x=0.00005 to 0.25.

In still another embodiment, the one or more lithium oxometallates can be a combination of the exemplary lithium oxometallates disclosed herein.

In another aspect, the present disclosure provides a lithium ion battery that includes a composite material having domains of one or more lithium oxometallates as disclosed herein in an electronically conductive matrix.

In another aspect, the present disclosure provides an electrode (e.g., a cathode or an anode) that includes a composite material having domains of one or more lithium oxometallates as disclosed herein in an electronically conductive matrix.

In another aspect, the present disclosure provides a lithium ion battery that includes at least one electrode (e.g., cathodes and/or anodes) that includes a composite material having domains of one or more lithium oxometallates as disclosed herein in an electronically conductive matrix.

In another aspect, the present disclosure provides methods of making a composite material including domains of one or more lithium oxometallates in an electronically conductive matrix.

In one embodiment, the method includes: adding LiX and optionally sources for optional dopants D and/or E in an optional solvent into a 3-dimensionally ordered macroporous (3DOM), nanoparticles, or nanocomposites of doped or undoped M^{a}O₂, M^{b}O₂, M^{a}O₂/C, M^{b}O₂/C, M^{a}O₂@3DOM C, or M^{b}O₂@3DOM C material; wherein M^{a} represents Zr and/or Sn; M^{b} represents Nb and/or Ta; D represents an optional dopant selected from the group consisting of Mg, Ag, Co, Ni, or a combination thereof; E represents an optional dopant selected from the group consisting of Ti, Nb, Ce, Mo, Y, Mn, Fe, or a combination thereof; and wherein X⁻ is an organic or inorganic anionic species; optionally drying the infiltrated material to remove at least a portion of the optional solvent; and pyrolyzing the optionally dried infiltrated material. Exemplary 3DOM materials are described, for example, in U.S. Pat. No. 6,680,013 (Stein et al.) Exemplary anionic species for X⁻ include, for example, hydroxide, acetate, acetylacetonate, fluoride, chloride, bromide, iodide, nitrate, perchlorate, sulfate, tetrafluoroborate, hexafluorophosphate, alkoxide, carbonate, borohydride, hydride, a carboxylate (e.g., benzoate, terephthalate, trimesate, and/or salicylate), phenoxide, naphthalate, imides optionally containing one or more aromatic rings (e.g., phthalimide), and combinations thereof. In some embodiments, the method further includes grinding the composite material to form nanoparticles. Suitable sources for optional dopants D and E include, for example, salts of the dopant metal with an appropriate anion (e.g., X⁻ as disclosed herein). In additional or alternative embodiments, dopants can also be introduced by post-synthetic ion exchange.

In another embodiment, the method of making a composite material including domains of one or more lithium oxometallates in a matrix includes:

providing a slurry of conductive particles and one or more doped or undoped lithium oxometallates in a solvent, and drying the slurry to form the composite material, wherein the one or more doped or undoped lithium oxometallates are as described herein above. Optionally, the method further includes delaminating sheets of the composite material.

Because lithium oxometallates as disclosed herien (e.g., Li₈M^{a}O₆ and/or Li₇M^{b}O₆) can have a higher theoretical capacity for lithium ions than current commercial cathode materials, lithium ion batteries including, for example, Li₈M^{a}O₆ and/or Li₇M^{b}O₆ composites may also have a higher practical capacity, which can translate into higher energy densities for rechargeable batteries. Further, some of the M components can be less expensive than the cobalt component used in current commercial lithium ion batteries. Li₈M^{a}O₆ and/or Li₇M^{b}O₆ composites are expected to provide higher capacity than current cathode materials. The resulting higher energy density can translate into batteries that last longer on each charge. Although the structure may not be stable upon loss of all Li, computational studies indicate that the structure would be stable when 2 Li are removed. Initial capacities over 200 mAh/g which was maintained at 78 mAh/g after 50 cycles have been observed at charge/discharge rates of C/5. Stable values are expected to be even higher when the size of the Li₈ZrO₆ is further reduced and/or the ionic conductivity of the Li₈ZrO₆ is improved by doping.

### Definitions

As used herein, “composite material” refers to materials made from two or more constituent materials with significantly different physical and/or chemical properties, that when combined, produce a material with characteristics different from the individual components. The individual components remain separate and distinct within the finished structure, for example, domains in a matrix.

As used herein, “active material” in a battery refers to a material that participates in one or more electrochemical charge/discharge reactions including, for example, redox reactions and the lithiation/delithiation reactions.

As used herein, “electronically conductive” matrix refers to a matrix that is composed of one or more conductive phases or conductive particles. A wide variety of conductive phases can be used such as those that are known for use in electrodes of lithium ion batteries. Exemplary conductive phases can include one or more of glassy carbon, carbon black or acetylene black (such as those available under the trade designations SUPER P Li, C-NERGY SUPER C65, C-NERGY SUPER C45), graphite (such as those available under the trade designations TIMREX KS 6 and C-NERGY KS 6L), and black powder for batteries available under the trade designation Ketjen black EC-600JD, from AkzoNobel, graphene sheets, and reduced graphene oxide. Other conductive particles can be nanoparticles such as conductive metallic nanoparticles.

As used herein, “nano-sized” domains refer to domains having a size smaller than 200 nm, in some embodiments smaller than 100 nm, in certain embodiments, smaller than 50 nm, or smaller than 20 nm. Exemplary domains can include nanoparticles (“NP,” e.g., particles having an average diameter of less than 200 nm) and/or nanosheets (e.g., sheets having a thickness less than 200 nm).

As used herein, “nanoporous” carbon refers to carbon having pores in the range of 10 nm to 5000 nm.

As used herein, “3DOM” refers to 3-dimensionally ordered macroporous structures or inverse opals (e.g., 3DOM C refers to a 3DOM carbon structure).

As used herein, the recitation of a “material@3DOM” means that the material is confined within the pores of the 3DOM structure (e.g., a “material@3DOM C” means that the material is confined within the pores of the 3DOM carbon structure).

As used herein, the recitation of a “material@C NP” means that nanoparticles of the material are confined within a layer of carbon.

As used herein, “specific capacity” refers to charge stored per mass of active electrode material in units of mAh/g.

The terms “comprises” and variations thereof do not have a limiting meaning where these terms appear in the description and claims.

As used herein, “a,” “an,” “the,” “at least one,” and “one or more” are used interchangeably.

Also herein, the recitations of numerical ranges by endpoints include all numbers subsumed within that range (e.g., 1 to 5 includes 1, 1.5, 2, 2.75, 3, 3.80, 4, 5, etc.).

The above brief description of various embodiments of the present invention is not intended to describe each embodiment or every implementation of the present invention. Rather, a more complete understanding of the invention will become apparent and appreciated by reference to the following description and claims in view of the accompanying drawings. Further, it is to be understood that other embodiments may be utilized and structural changes may be made without departing from the scope of the present invention.

### BRIEF DESCRIPTION OF THE DRAWINGS

FIG. 1 is an illustration of an exemplary unit cell of Li₈ZrO₆ (Duan, Phys. Chem. Chem. Phys. 2013, 15:9752-9760). Two of the eight lithium ions form layers with ZrO₆⁸⁻, while the remaining lithium ions are located between the layers.

FIG. 2 illustrates (a) a comparison of the calculated x-ray diffraction (XRD) pattern of Li₈ZrO₆ as determined from density functional theory using the M06-L functional to the experimental pattern and the pattern of the Rietveld-refined structure, wherein the residual trace confirms the close match between the experimental and Rietveld patterns; and (b) an exemplary experimental XRD pattern for the Y—Li₈ZrO₆/C composite material used for galvanostatic charging/discharging over 50 cycles. The asterisk marks a reflection corresponding to a minor Li₂O secondary phase.

FIG. 3 illustrates (a) galvanostatic charge/discharge curves of an exemplary Y—Li₈ZrO₆/C composite half-cell, wherein a current density corresponding to C/5 was used for all cycles shown, except the 11^{th} cycle (C/2) and the 21^{st} cycle (C); and (b) the specific capacity of the cell (per g of Y—Li₈ZrO₆) measured over 50 cycles at the indicated C-rates.

FIG. 4 is an illustration of the determination of the optical band gap of Li₈ZrO₆ to be 5.75 eV using the Tauc plot obtained from a UV-vis spectrum.

FIG. 5 is an illustration of exemplary partial ex-situ powder XRD patterns of electrode films made from a Li₈ZrO₆/C composite before charging, after the first charge, and after the first discharge.

FIG. 6 is an illustration of exemplary x-ray photoelectron spectroscopy (XPS) spectra showing the position of the O₁ₛ peak of a Li₈ZrO₆/C composite cathode before charge, after the first charge, and after the first discharge. A spectrum of neat Li₈ZrO₆ is included to demonstrate that the O₁ₛ peak position is not affected by the composite preparation. The O₁ₛ peak shifts to higher binding energy after partial delithiation, relating to an increase in oxidation state of oxygen.

FIG. 7 is a schematic illustration of an exemplary synthesis of lithium oxozirconate (LZO)@3DOM C. 3DOM carbon was synthesized from resorcinol-formaldehyde (RF) sol using a PMMA CC as the template. The precursor of ZrO₂ was then infiltrated and pyrolyzed. The ZrO₂ within the pores was further converted to LZO using lithium acetate.

FIG. 8 illustrates (a) an exemplary XRD pattern of LZO@3DOM C, wherein reflections marked with an asterisk (*) correspond to a Li₆Zr₂O₇ impurity and those marked with a dot (·) to a Li₂O impurity; (b) exemplary scanning electron microscopy (SEM) images of ZrO₂@3DOM C; and (c) exemplary SEM images of LZO@3DOM C.

FIG. 9 is an illustration of the electrochemical performance of exemplary LZO@3DOM C showing (a) charge and discharge curves; and (b) rate performance of LZO@3DOM C compared with bulk LZO.

FIG. 10 is a schematic illustration of the conversion from ZrO₂ nanoparticles (NP) to LZO@C NP. The carbon formed from the benzoate anion coating the nanoparticles.

FIG. 11 is an illustration of (a) an XRD pattern of exemplary ZrO₂ NP. Sharp (#) for sample holder; (b) a TEM image of exemplary ZrO₂ NP; (c) XRD pattern of exemplary LZO@C NP, wherein reflections marked with an asterisk (*) correspond to a Li₆Zr₂O₇ impurity and those marked with a dot (·) correspond to a Li₂O impurity; and (d) an SEM image of exemplary LZO@C NP.

FIG. 12 is an illustration of the electrochemical performance of exemplary LZO@C NP showing (a) charge and discharge curves; and (b) rate performance.

FIG. 13 is a summary of grain size reduction methods, indicating exemplary precursors, smallest grain sizes achieved to-date, and other relevant observations.

FIG. 14 is an illustration of (a) an XRD pattern of exemplary Li₈ZrO₆ synthesized with the presence of carbon nanotubes (CNTs) and phenol-formaldehyde (PF) sol; (b) a correlation of the mass of PF sol added, the carbon content in the product, and the crystallite size of LZO; (c) an SEM image of exemplary LZO CNT PF 2.0; and (d) the effect of crystallite size and carbon content on the electrochemical performance.

FIG. 15 is an illustration of the effect of Ag doping on charge- and discharge behavior of Li₈ZrO₆, showing (a) the first cycle, (b) the second cycle, and (c) capacities at different cycling rates. Capacity from low to high: undoped, Li_{7.56}Ag_{0.04}ZrO₆, and Li_{7.40}Ag_{0.60}ZrO₆.

FIG. 16 is an illustration of (a) a UV-vis spectra, showing decreased band gaps for exemplary Mg 0.04, Ce 0.04 and Nb 0.04 doped Li₈ZrO₆; (b) photoluminescence spectra of exemplary Ti 0.04 doped Li₈ZrO₆; (c) the corresponding computed band diagram; and (d) conductivity measurements. The ionic conductivity of Mg and Nb doped samples were improved significantly.

### DETAILED DESCRIPTION OF ILLUSTRATIVE EMBODIMENTS

Enhanced utilization of electrode material and improved charge and discharge rates are possible by employing electrode materials composed of nanosized particles. Much progress has been made using this approach for electrodes targeting both batteries and supercapacitors. Insertion materials with poor ion diffusion properties can reach nearly full theoretical capacity at room temperature if particle dimensions are on the order of a few nm. In particular, for thin electrode layers on two-dimensional supports, high charge and discharge rates have been demonstrated and new charge storage materials (such as Si) have delivered high specific capacities. Furthermore, there has been recent evidence that reducing electrode particle size can improve reversibility for materials that exhibit low reversibility in their bulk form.

Another approach to improve the kinetics and charge storage capacity in electrode materials with limited conductivity has been to “wire” particles of active material together with more conductive phases, including carbon, silicon, metals, ruthenia, and conducting polymers. For example, materials like LiFePO₄, with an electron conductivity of 10⁻⁹-10⁻¹⁰ S/cm at 25° C., can reach nearly all of their theoretical capacity if carbon is added in an appropriate way. This approach is particularly effective if both phases have nanometer dimensions, e.g., for nanocrystalline active phases self-assembled together with graphene.

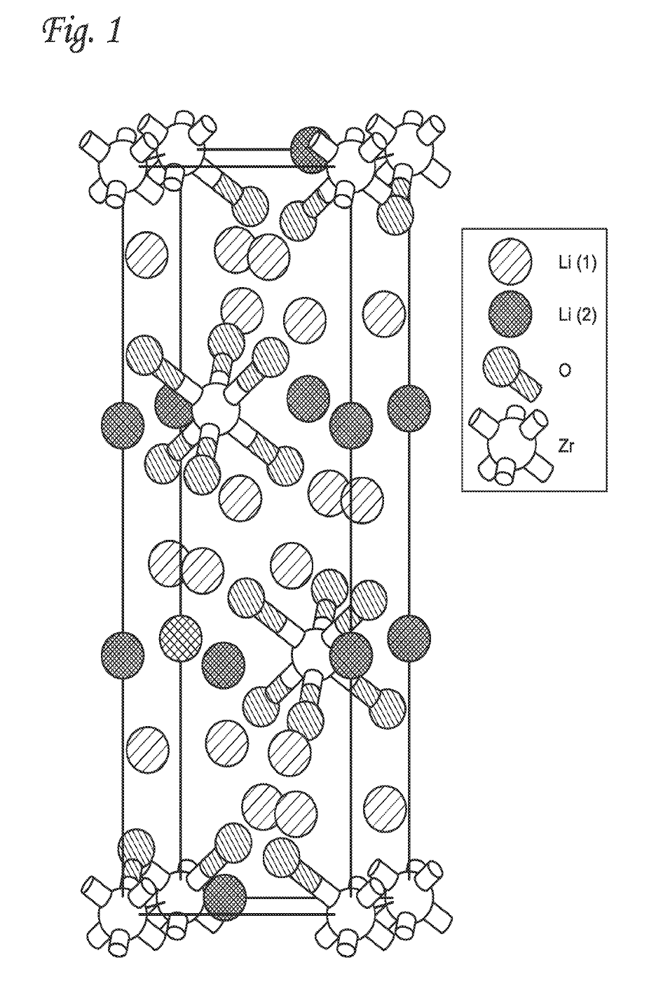

Li₈ZrO₆ is a compound with very high lithium content per formula unit, making it a potential cathode material with high capacity. Li₈ZrO₆ has a higher theoretical specific capacity for charge storage than existing cathodes in commercial Li-ion batteries. The electrode material consists of relatively inexpensive and abundant elements and can provide improved sustainability and potential cost reductions for battery materials. Li₈ZrO₆ has a layered structure, in which oxygen atoms form close-packed planes, and all zirconium atoms occupy octahedral voids. Two out of the eight lithium ions occupy octahedral voids, while the rest are in the tetrahedral sites, as shown in FIG. 1 (Duan, Phys. Chem. Chem. Phys. 2013, 15:9752-9760). Extracting each lithium ion from a Li₈ZrO₆ unit provides a specific capacity of 110.5 mAh/g. If two or more lithium ions are electrochemically active, an improvement in the capacity over commercialized materials can be expected.

However, the poor electronic conductivity of Li₈ZrO₆ may limit its performance at high rates (Pantyukhina et al., Russ. J. Electrochem. 2010, 46, 780-783). To compensate for this short-coming, the feature size of Li₈ZrO₆ can be decreased, a good contact with a conductive phase can be established, and nanocomposites of Li₈ZrO₆ and carbon can be synthesized.

Disclosed herein is a new active material for lithium ion batteries including, for example, rechargeable lithium ion batteries. In particular, this disclosure relates a material capable of reversibly incorporating a large fraction of lithium ions relative to the active material mass to provide high energy densities. Composite materials having domains of one or more lithium oxometallates as disclosed herein in an electronically conductive matrix, can be used in lithium ion batteries, for example, as an active material such as an electrode that can store charge in the form of lithium ions. For example, although the material can include Li₈ZrO₆, a compound that is an electrical insulator in the bulk, the use of composites of Li₈ZrO₆ with an efficient conductive phase is particularly useful, because the content of lithium ions relative to mass is higher than in other cathode materials that are currently used in commercial lithium ion batteries. The use of lithium oxometallates as disclosed herein (e.g., Li₈ZrO₆) is also attractive because it does not have at least some of the disadvantages of currently used cathode materials that contain cobalt, including cost and resource limitations.

In one aspect, the present disclosure provides a composite material. In one embodiment, the composite material has domains of one or more lithium oxometallates in an electronically conductive matrix, wherein the one or more lithium oxometallates are of the formula Li₈M^{a}O₆, Li₇M^{b}O₆, or a doped lithium oxometallate thereof, wherein M^{a} represents Zr and/or Sn, and M^{b} represents Nb and/or Ta. In some embodiments, the domains (e.g., nano-sized domains) of Li₈M^{a}O₆ and/or Li₇M^{b}O₆ include particles (e.g., nanoparticles) and/or sheets (e.g., nanosheets) of Li₈M^{a}O₆ and/or Li₇M^{b}O₆.

In one embodiment, the doped lithium oxometallate of the formula Li₈M^{a}O₆ further includes a lithium replacing dopant and is of the formula Li₍₈₋ₙₓ₎DₓM^{a}O₆, wherein M^{a} represents Zr and/or Sn; D represents an optional lithium replacing dopant selected from the group consisting of Mg, Ag, Co, Ni, or a combination thereof; n represents the formal oxidation state of the dopant D; and x=0.00005 to 2.

In another embodiment, the doped lithium oxometallate of the formula Li₈M^{a}O₆ further includes: a Li and M^{a} replacing dopant, wherein the doped lithium oxometallate is of the formula Li₍₈₋ₓ₍ₙ₋₄₎₎EₓM^{a}₍₁₋ₓ₎O₆, wherein M^{a} represents Zr and/or Sn; E represents a Li and M^{a} replacing dopant selected from the group consisting of Ti, Nb, Ce, Mo, Y, Mn, Fe, or a combination thereof; n represents the formal oxidation state of the dopant E; and x=0.00005 to 0.25; an M^{a} and 0 replacing dopant, wherein the doped lithium oxometallate is of the formula Li₈EₓM^{a}₍₁₋ₓ₎O_{(6-(n-4)x/2)}, wherein M^{a} represents Zr and/or Sn; E represents an M^{a} and O replacing dopant selected from the group consisting of Ti, Nb, Ce, Mo, Y, Mn, Fe, or a combination thereof; n represents the formal oxidation state of the dopant E; and x=0.00005 to 0.25; or a Li, M^{a}, and O replacing dopant, wherein the composition of the doped lithium oxometallate corresponds to a combination of the formulas Li₍₈₋ₓ₍ₙ₋₄₎₎EₓM^{a}₍₁₋ₓ₎O₆ and Li₈EₓM^{a}₍₁₋ₓ₎O_{(6+(n-4)x/2)}, wherein M^{a} represents Zr and/or Sn; E represents a Li, M^{a}, and O replacing dopant selected from the group consisting of Ti, Nb, Ce, Mo, Y, Mn, Fe, or a combination thereof; n represents the formal oxidation state of the dopant E; and x=0.00005 to 0.25.

In another embodiment, the doped lithium oxometallate of the formula Li₇M^{b}O₆ further includes a lithium replacing dopant and is of the formula Li₍₇₋ₙₓ₎DₓM^{b}O₆, wherein M^{b} represents Nb and/or Ta; D represents an optional lithium replacing dopant selected from the group consisting of Mg, Ag, Co, Ni, or a combination thereof; n represents the formal oxidation state of the dopant D; and x=0.00005 to 2.

In another embodiment, the doped lithium oxometallate of the formula Li₇M^{b}O₆ further includes: a Li and M^{b} replacing dopant, wherein the doped lithium oxometallate is of the formula Li₍₇₋ₓ₍ₙ₋₅₎₎EₓM^{b}₍₁₋ₓ₎O₆, wherein M^{b} represents Nb and/or Ta; E represents a Li and M^{b} replacing dopant selected from the group consisting of Ti, Nb, Ce, Mo, Y, Mn, Fe or a combination thereof; n represents the formal oxidation state of the dopant E; and x=0.00005 to 0.25; an M^{b} and O replacing dopant, wherein the doped lithium oxometallate is of the formula Li₇EₓM^{b}₍₁₋ₓ₎O_{(6+(n-5)x/2)}, wherein M^{b} represents Nb and/or Ta; E represents an M^{b} and O replacing dopant selected from the group consisting of Ti, Nb, Ce, Mo, Y, Mn, Fe, or a combination thereof; n represents the formal oxidation state of the dopant E; and x=0.00005 to 0.25; or a Li, M^{b}, and O replacing dopant, wherein the composition of the doped lithium oxometallate corresponds to a combination of the formulas Li₍₇₋ₓ₍ₙ₋₅₎₎EₓM^{b}₍₁₋ₓ₎O₆ and Li₇EₓM^{b}₍₁₋ₓ₎O_{(6+(n-5)x/2)}, wherein M^{b} represents Nb and/or Ta; E represents a Li, M^{b}, and O replacing dopant selected from the group consisting of Ti, Nb, Ce, Mo, Y, Mn, Fe, or a combination thereof; n represents the formal oxidation state of the dopant E; and x=0.00005 to 0.25.

In still another embodiment, the one or more lithium oxometallates can be a combination of the exemplary lithium oxometallates disclosed herein.

In certain embodiments, the electronically conductive matrix includes conductive carbon, that in some embodiments can be nanoporous carbon. A wide variety of conductive phases can be used such as those that are known for use in electrodes of lithium ion batteries. Exemplary conductive phases can include one or more of glassy carbon, carbon black or acetylene black (such as those available under the trade designations SUPER P Li, C-NERGY SUPER C65, C-NERGY SUPER C45), graphite (such as those available under the trade designations TIMREX KS 6 and C-NERGY KS 6L), and black powder for batteries available under the trade designation Ketjen black EC-600JD, from AkzoNobel, graphene sheets, and reduced graphene oxide. Other conductive particles can be nanoparticles such as conductive metallic nanoparticles.

In some embodiments, the composite material further includes a polymeric binder. A wide variety of polymeric binders can be used. Exemplary polymeric binders and binder/solvent combinations include, for example, polyacrylic acid (PAA)/N-methyl-2-pyrrolidone (NMP), poly(vinyldiene fluoride) (PVDF)/NMP, PAA/water, sodium carboxymethyl cellulose (CMC)/water, alginate/water, poly(methyl methacrylate) (PMMA)/NMP, poly(vinylidenefluoride-co-hexafluoropropylene) (PVDF-HFP)/NMP, CMC/styrene butadiene rubber (SBR)/water, styrene-butadiene rubber (SBR), polytetrafluoroethylene (PTFE), carboxymethyl cellulose (CMC), water-based aqueous binders, and combinations thereof.

In another aspect, the present disclosure provides a lithium ion battery that includes a composite material having domains of one or more lithium oxometallates as disclosed herein in an electronically conductive matrix. In certain embodiments, the lithium ion battery is a rechargeable lithium ion battery.

In another aspect, the present disclosure provides an electrode (e.g., a cathode or an anode) that includes a composite material having domains of one or more lithium oxometallates as disclosed herein in an electronically conductive matrix.

In another aspect, the present disclosure provides a lithium ion battery that includes at least one electrode (e.g., cathodes and/or anodes) that includes a composite material having domains of one or more lithium oxometallates as disclosed herein in an electronically conductive matrix.

In another aspect, the present disclosure provides methods of making a composite material including domains of one or more lithium oxometallates in an electronically conductive matrix.

In one embodiment, the method includes: adding LiX and optionally sources for optional dopants D and/or E in an optional solvent into a 3-dimensionally ordered macroporous (3DOM), nanoparticles, or nanocomposites of doped or undoped M^{a}O₂, M^{b}O₂, M^{a}O₂/C, M^{b}O₂/C, M^{a}O₂@3DOM C, or M^{b}O₂@3DOM C material; wherein M^{a} represents Zr and/or Sn; M^{b} represents Nb and/or Ta; D represents an optional dopant selected from the group consisting of Mg, Ag, Co, Ni, or a combination thereof; E represents an optional dopant selected from the group consisting of Ti, Nb, Ce, Mo, Y, Mn, Fe, or a combination thereof; and wherein X⁻ is an organic or inorganic anionic species; optionally drying the infiltrated material to remove at least a portion of the optional solvent; and pyrolyzing the optionally dried infiltrated material. Exemplary 3DOM materials are described, for example, in U.S. Pat. No. 6,680,013 (Stein et al.) Exemplary anionic species for X⁻ include, for example, hydroxide, acetate, acetylacetonate, fluoride, chloride, bromide, iodide, nitrate, perchlorate, sulfate, tetrafluoroborate, hexafluorophosphate, alkoxide, carbonate, borohydride, hydride, a carboxylate (e.g., benzoate, terephthalate, trimesate, and/or salicylate), phenoxide, naphthalate, imides optionally containing one or more aromatic rings (e.g., phthalimide), and combinations thereof. In some embodiments, the method further includes grinding the composite material to form nanoparticles. Suitable sources for optional dopants D and E include, for example, salts of the dopant metal with an appropriate anion (e.g., X⁻ as disclosed herein). In additional or alternative embodiments, dopants can also be introduced by post-synthetic ion exchange.

A wide variety of solvents can be used for infiltration. Exemplary solvents include, for example, water, methanol, ethanol, tetrahydrofuran, acetone, and combinations thereof.

In some embodiments, pyrolyzing includes heating at temperatures of 500° C. to 1000° C. for 1 to 12 hours. In certain embodiments, pyrolyzing includes heating at temperatures of 600° C. to 900° C. for 2 to 10 hours. The heating can be, for example, in nitrogen and/or argon.

In another embodiment, the method of making a composite material including domains of one or more lithium oxometallates in a matrix includes: providing a slurry of conductive particles and one or more doped or undoped lithium oxometallates in a solvent, and drying the slurry to form the composite material, wherein the one or more doped or undoped lithium oxometallates are as described herein above.

In some embodiments, the method further includes delaminating sheets of the composite material. Because the Li₈MO₆ structures are layered, they are amenable to delamination or exfoliation (taking the layers apart), that may produce the desired nanoparticles. The delamination process can involve ultrasonication in a suitable solvent, possibly aided by intercalation with other cations (e.g, tetraalkylammonium cations, cationic surfactants, etc.).

A wide variety of solvents can be used. Exemplary solvents include, for example, water, N-methyl 2-pyrrolidone, tetrahydrofuran, acetone, 1,2-dichlorobenzene, 2-butanone, dimethyl sulfoxide, 2-chlorophenol, and combinations thereof.

In some embodiments, the slurry further includes a polymeric binder. A wide variety of polymeric binders can be used. Exemplary polymeric binders and binder/solvent combinations include, for example, polyacrylic acid (PAA)/N-methyl-2-pyrrolidone (NMP), poly(vinyldiene fluoride) (PVDF)/NMP, PAA/water, sodium carboxymethyl cellulose (CMC)/water, alginate/water , poly(methyl methacrylate) (PMMA)/NMP, poly(vinylidenefluoride-co-hexafluoropropylene) (PVDF-HFP)/NMP, CMC/styrene butadiene rubber (SBR)/water, styrene-butadiene rubber (SBR), polytetrafluoroethylene (PTFE), carboxymethyl cellulose (CMC), water-based aqueous binders, and combinations thereof.

Optionally, the slurry can be applied to (e.g., coated on) a support. In certain embodiments, drying the applied slurry forms a film of the composite material.

In summary, it has been demonstrated that Li₈ZrO₆ with particle size <200 nm can function as a cathode material when combined with a relatively large amount of conductive carbon additive. Further, reducing the particle size is expected to reduce polarization effects that result from the high electrical resistance of the bulk particles. Further, it is expected that the amount of conductive carbon can be reduced when using the smaller particles of Li₈ZrO₆ (e.g., nanoparticles) such that a larger fraction of the electrode can be active material.

The present invention is illustrated by the following examples. It is to be understood that the particular examples, materials, amounts, and procedures are to be interpreted broadly in accordance with the scope and spirit of the invention as set forth herein.

### EXAMPLES

### Example 1

An Y-doped Li₈ZrO₆/C composite cathode exhibited an initial discharge capacity of over 200 mAh/g at charge/discharge rates of C/5, with 78 mAh/g maintained after 50 cycles.

Materials. Zirconyl nitrate (99%), yttrium nitrate hexahydrate (99%), lithium benzoate (98%), tetrahydrofuran (THF, HPLC grade), N-methyl pyrrolidone (NMP, anhydrous, 99.5%), were purchased from Sigma Aldrich. Concentrated nitric acid was purchased from Macron Chemicals. Super P carbon, electrolyte (1 M LiPF₆ in 1:1:1 ethylene carbonate, dimethyl carbonate, and diethyl carbonate by volume), and polyvinylidene diflouride (PVDF) were purchased from MTI Corporation. Carbon-coated aluminum foil was obtained from ExoPack. Celgard 3501 polypropylene membrane films were obtained from Celgard. Nitrate precursors were dried in an oven at 110° C. for at least 4 hours prior to use to obtain a consistent mass. Deionized water was produced on site using a Barnstead Sybron purification system (final resistivity >18 MΩ·cm).

Preparation of Y—Li₈ZrO₆/C nanocomposites. An yttria-doped sample was prepared starting from yttria-doped ZrO₂ nanoparticles on the surface of conductive carbon, which were prepared following a synthesis of yttria-doped ZrO₂ nanoparticles adapted from Jiang et al., J. Mater. Res. 1994, 11, 2318-2324. Zirconyl nitrate (3.24 mmol) and yttrium nitrate (0.207 mmol) were dissolved in a solution of nitric acid (0.2 g) and DI water (15.8 g). The solution was added in four parts to Super P carbon (1.66 g), with each part thoroughly mixed with a mortar and pestle, then dried before adding the next portion. After the final addition, the mixture was dried at 110° C. for 1 hour, heated to 400° C. under static air at 2° C./minute, then cooled naturally to ambient temperature. The nanoparticles were converted to Li₈ZrO₆ by ball milling the ZrO₂/C with lithium benzoate at 10:1 Li:Zr (based on residual mass from thermogravimetric analyzsis) for 5 minutes, then carbonizing the composite at 900° C. with a 1° C./minute ramp to 600° C., followed by a 2 hour hold, then 2° C./minute to 900° C., followed by another 2 hour hold, all under 0.5 L/minute N₂ flow. The product was allowed to completely cool to room temperature before being removed from the inert atmosphere as partial self-combustion can occur at temperatures exceeding approximately 35° C. in the presence of oxygen. The final product contained 72.1 wt % carbon, as determined by combustion-based analysis, performed by Atlantic Microlabs, Norcross, Ga., and is referred to as Y—Li₈ZrO₆/C.

Electrochemical Characterization. Electrodes were made from the Y—Li₈ZrO₆/C composites by adding PVDF (200 mg of a 10 wt % solution in NMP) and additional NMP approximately 1 mL) to the composite material and mixing for 5 minutes to create a viscous slurry with a final dry composition of 90:10 composite:PVDF by weight. The slurries were then cast onto carbon-coated aluminum foil using a doctor blade and dried at ambient temperature in a dry room maintained below 20 ppm H₂O, or 1% relative humidity during active use. The dried film was pressed using a roller press to approximately half of its original thickness (final thickness was approximately 250 μm) and 0.5-inch diameter disks were punched out. Active material loading was between 2 and 2.5 mg/cm². The electrodes were assembled into CR2032 coin cells in a half-cell configuration with metallic lithium as the counter electrode. A Celgard 3501 polypropylene membrane was used as the separator. The commercial electrolyte purchased from MTI was used as the electrolyte, and a wave spring was used behind the current collectors to maintain pressure and electrical contact within the cell. All assembly was done in a He-filled glove box. All galvanostatic cycling was performed between 1.3 and 4.5 V vs Li/Li⁺ with the C-rate defined as 110.5 mA/g, corresponding to 1 Li⁺/Li₈ZrO₆/h in the electrode. The electrochemical tests were performed on an Arbin Instruments BT-2000 electrochemical interface. These composite materials were also used for ex-situ X-ray diffraction (XRD) and X-ray photoelectron spectroscopy (XPS).

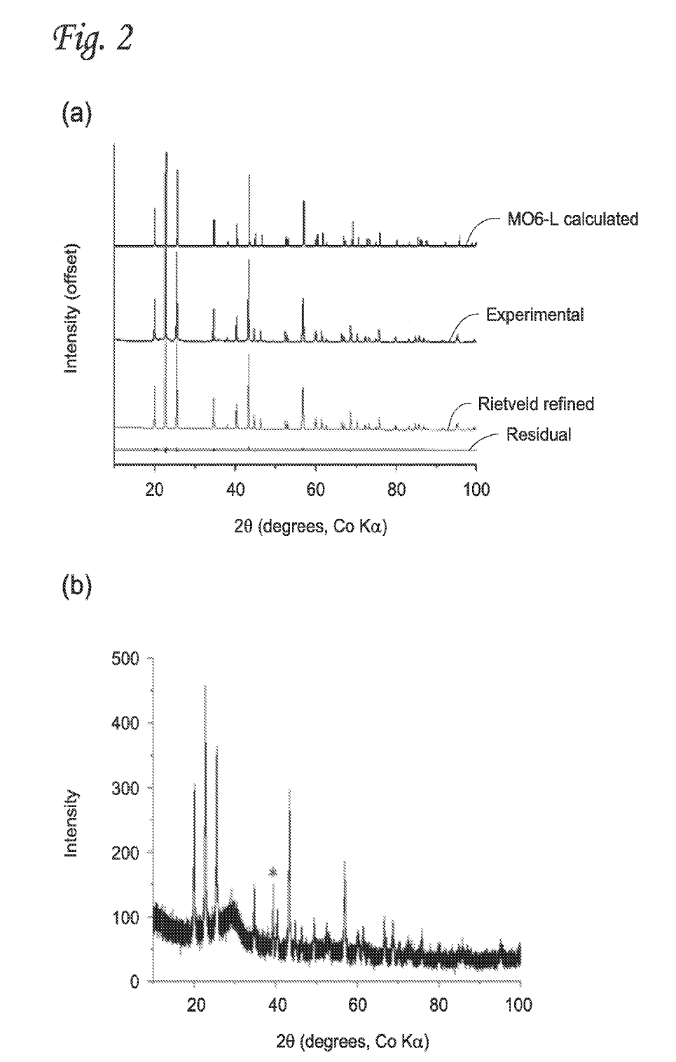

Results. The powder pattern of the Y—Li₈ZrO₆/C composite (FIG. 2) matches the Rietveld refined pattern of Li₈ZrO₆ (FIG. 2a), indicating that the yttria doping does not significantly alter the crystal structure. Using the full-width-at-half-maximum of the (101) peak at 22.8°θ corrected for instrumental broadening, the Scherrer broadening gives an average grain size of 42 nm.

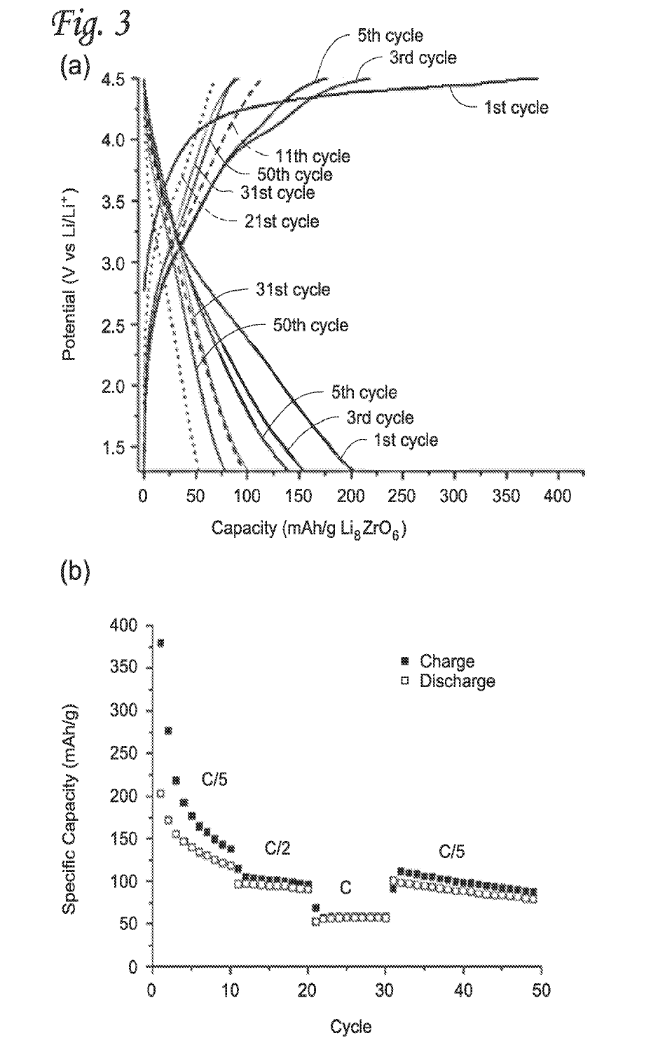

To increase utilization of the Li₈ZrO₆ cathode material, an Y-doped precursor was employed, which together with carbon phases introduced from Super P carbon and carbonization of lithium benzoate, reduced the average grain size of Y—Li₈ZrO₆ to 42 nm and provided a more intimate contact with the conductive carbon. These factors have been shown in other battery electrode materials to significantly improve electrochemical performance (Petkovitch et al. Inorg. Chem. 2014, 53, 1100-1112; and Vu et al., Chem. Mater. 2011, 23, 3237-3245). For the first delithiation step, a significantly different profile is observed compared to the other cycles, possibly due to a conditioning effect of removing the first few lithium ions from the material (FIG. 3). This would explain the subsequent cycles showing shoulders at a lower potential, matching the computational prediction that the first Li⁺ is more difficult to remove than the second. After the first cycle, two features appear on the charge cycle, a shoulder at 3.2 V and one at 4.1 V, with the second peak matching that of the undoped material. The discharge curves also show a shoulder at 2.3 V, which corresponds to the step at 2.1 V in the undoped material. The first discharge of the cell shows a remarkable 203 mAh/g at a rate of C/5, corresponding to 1.85 Li⁺ ion per formula unit. After the rate was increased to C/2, the capacity remained at 96 mAh/g, or 0.87 Li⁺/Li₈ZrO₆, and at C-rate, the discharge capacity was 53 mAh/g. After 50 cycles, the discharge capacity still remained at 78 mAh/g at C/5, showing good promise for further study as a cathode material. By doping the Li₈ZrO₆ with yttria to reduce grain size it was possible to increase specific capacity significantly compared to Li₈ZrO₆ with grain size >100 nm.

### Example 2

Materials. Lithium nitrate (99%), zirconium oxynitrate hydrate (99%), zirconium acetate hydroxide [Zr(C₂H₃O₂)ₓ(OH)_{y}, x+y≈4], phenol (>99%), formaldehyde (aqueous solution, 37 wt %), tetrahydrofuran (THF, HPLC grade), N-methyl pyrrolidone (NMP, anhydrous, 99.5%), sodium hydroxide, and hydrochloric acid (approximately 37 wt %) were purchased from Sigma Aldrich. Lithium acetate dihydrate was purchased from Johnson Matthey Company. SuperP carbon, electrolyte (1 M LiPF₆ in 1:1:1 ethylene carbonate, dimethyl carbonate, and diethyl carbonate by volume), and polyvinylidene diflouride (PVDF) were purchased from MTI Corporation. Carbon-coated aluminum foil was obtained from ExoPack. Celgard 3501 polypropylene membrane films were obtained from Celgard. Nitrate precursors were dried in an oven at 110° C. for at least 4 hours prior to use to obtain a consistent mass. Molar calculations were performed using the anhydrous basis for the nitrate precursors, and 243.22 g/mol was used for zirconium acetate hydroxide [Zr(C₂H₃O₂)ₓ(OH)_{y}, x=y=2].

Preparation of Phenol-Formaldehyde Resol. A phenol-formaldehyde resol (PF) was prepared according to an established synthesis (Meng et al., Angew. Chem. Int. Ed. 2005, 43, 7053-7059). Briefly, phenol (61 g) was melted at 50° C. in a 500 mL glass round bottom flask and a 20 wt % aqueous NaOH solution (13.6 g) was then added dropwise. Aqueous formaldehyde (37 wt %, 200 mL) was subsequently added dropwise while stirring at 300 rpm with a Teflon-coated magnetic stir bar. The resulting solution was heated to 70° C. and left stirring for 1 hour to increase the extent of polymerization. The as-made product was neutralized to pH of approximately 7 using aqueous HCl (0.6 M, approximately 30 mL) followed by the removal of water through rotary evaporation. The polymer was re-dissolved in THF to a final concentration of 50 wt % and left to rest overnight to allow the precipitated NaCl to sediment. The polymer solution was decanted to obtain the final product and stored in a refrigerator as a stock solution until use.

Preparation of Li₈ZrO₆. Li₈ZrO₆ was synthesized as a microcrystalline powder by the thermal decomposition of nitrate precursors, following a procedure slightly modified from a previous published synthesis (Yin et al., Inorg. Chem. 2011, 50, 2044-2050). Zirconium oxynitrate (4.2 mmol) and lithium nitrate (42 mmol) were ball-milled in a zirconia ball and cup set for 5 minutes and then calcined in a covered alumina crucible at 2° C./minute to 600° C., followed by a 3 hour isothermal step, further heating at 2° C./minute to 800° C., and an additional 2 hour isothermal step at 800° C. The as-made product was ground to a fine powder using an agate mortar and pestle prior to further analysis.

Preparation of Li₈ZrO₆/C Composites. To intimately mix the active material with a conductive phase, a more complex composite synthesis was used. First, zirconium acetate hydroxide (4.1 mmol), lithium acetate dihydrate (41 mmol), and SuperP carbon (0.25 g) were ball milled for 5 minutes, followed by the addition of 0.25 g of the stock PF solution. The composite was mixed well prior to curing the resol at 120° C. for 24 h. The dry powder was briefly ground using an agate mortar and pestle prior to pyrolysis under 0.5 L/minute N₂ following the same thermal parameters as for the bulk Li₈ZrO₆. The final product was found to be 22.1 wt % carbon, as determined by combustion-based analysis, performed by Atlantic Microlabs, Norcross, Ga.

Electrochemical Characterization. Electrodes were made from the Li₈ZrO₆/C composites by first grinding SuperP carbon (26.0 mg) and the composite (154 mg) using an agate mortar and pestle for 5 minutes to create a uniform mixture.

PVDF (200 mg of a 10 wt % solution in NMP) and additional NMP (approximately 1 mL) were added and mixed for another 5 minutes to create a viscous slurry with a final dry composition of 60:30:10 Li₈ZrO₆:C:PVDF by weight. This was then cast onto carbon-coated aluminum foil using a doctor blade and dried at ambient temperature in a dry room maintained below 20 ppm H₂O, or 1% relative humidity during active use. The dried film was pressed using a roller press to approximately half of its original thickness (final thickness of approximately 250 μm) and 0.5-inch diameter disks were punched out. Active material loading was between 2 and 2.5 mg/cm². The electrodes were assembled into CR2032 coin cells in a half-cell configuration with metallic lithium as the counter electrode. A Celgard 3501 polypropylene membrane was used as the separator. The commercial electrolyte purchased from MTI was used as the electrolyte, and a wave spring was used behind the current collectors to maintain pressure and electrical contact within the cell. All assembly was done in a He-filled glove box. All galvanostatic cycling was performed between 1.3 and 4.5 V vs Li/Li⁺ with a current density of 22 mA/g Li₈ZrO₆ in the electrode. The electrochemical tests were performed on an Arbin Instruments BT-2000 electrochemical interface. These composite materials were also used for ex-situ X-ray diffraction (XRD) and X-ray photoelectron spectroscopy (XPS).

Product Characterization. Powder XRD of the microcrystalline Li₈Zro₆ powder was performed on a PANalytical X'Pert PRO diffractometer using a Co anode at 45 kV and 40 mA and an X'Celerator detector. Rietveld refinement was performed using PANalytical X'Pert Hi-Score Plus software to a final R-value of 4.39 and a goodness-of-fit of 10.1. Ex-situ powder XRD analysis was performed on composite electrodes by attaching the discs to an oriented Si wafer using Kapton tape to maintain uniform sample height all samples. A series of coin cells was made from a single film and run at a constant current of 22 mA/g Li₈ZrO₆ (C/5) to different charged or discharged states, followed by cell disassembly and ex-situ powder XRD analysis. XPS was performed using a Surface Science SSX-100 spectrometer equipped with an Al anode operated at 10 kV potential and 20 mA current over a spot size of 0.64 mm². Peak positions were calibrated against the C₁ₛ(sp³) peak of (adventitious) carbon, set at 284.6 eV. Diffuse reflectance UV-vis spectra were collected with a Thermo Scientific Evolution 220 spectrometer. Data were collected in the 190-800 nm range. A Kubelka-Munk transformation (Kubelka et al., Z. Tech. Phys. 1931, 12, 593-601) was performed on the UV-vis spectrum of Li₈ZrO₆ using the following equation

$$F ( R ) = \frac{{( 1 - R )}^{2}}{2 R} \qquad ( 4 )$$

in which F(R) is the Kubelka-Munk remission function, and R is reflectance (Lopez et al., J. Sol-Gel Sci. Technol. 2012, 61, 1-7).

The UV-vis spectrum of semiconductors near the absorption edge is described by the following equation

F(R)hv=B(hv−E_{g})ⁿ (5)

in which hv is the energy of a photon, B is a coefficient, and E_{g} is the band gap. For allowed transitions with an indirect band gap, as is the case for Li₈ZrO₆ according to our computational results, n=2. To determine the optical band gap, (F(R)hv)^{1/2} was plotted against hv (which is known as a Tauc plot; Tauc et al., Physica Status Solidi (b) 1966, 15, 627-637), and E_{g} was obtained by extrapolating the linear part to F(R)=0.

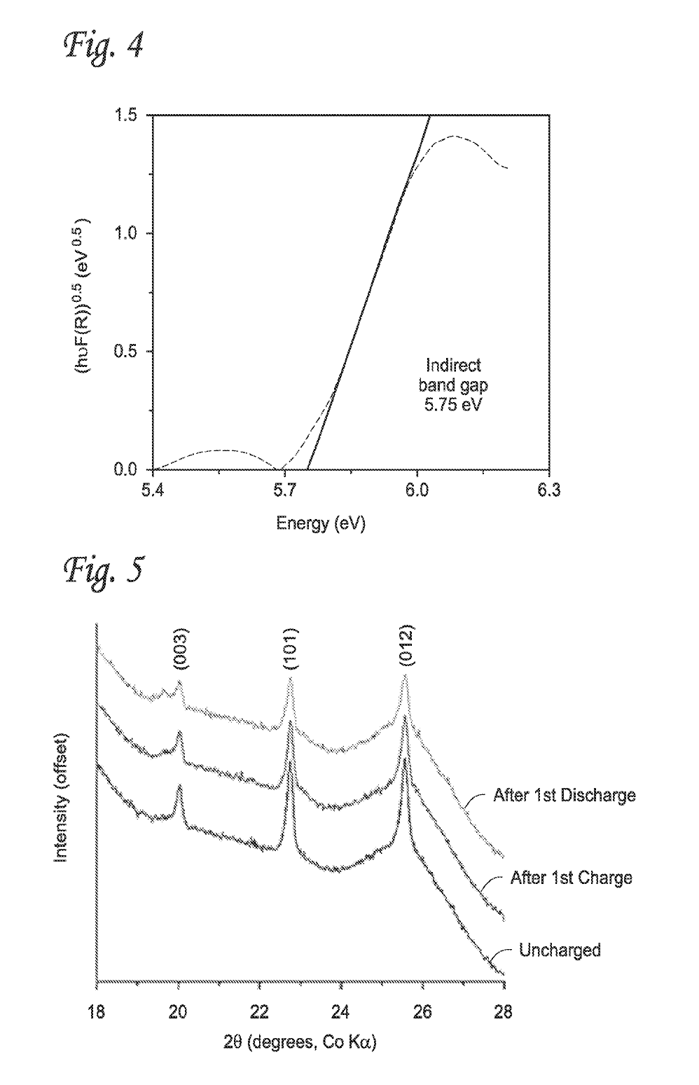

Results. The structure of Li₈ZrO₆ was determined by Rietveld refinement of the powder X-ray diffraction pattern of microcrystalline Li₈ZrO₆ (FIG. 2a). This confirmed the structure of Li₈ZrO₆ that was previously only established by analogy to the powder pattern of Li₈SnO₆ (Mühle et al., Inorg. Chem. 2004, 43, 874-881; and Delmas et al., Mat. Res. Bull. 1979, 14, 619-625). The band gap of Li₈ZrO₆ was determined from the diffuse reflectance UV-vis spectrum (shown in FIG. 4) by applying a Kubelka-Munk transformation and Tauc plot, as discussed in the experimental section. This indicated a band gap of 5.75 eV, which was within the range calculated by M06-L and HSE06. This large band gap signifies that Li₈ZrO₆ has poor electronic conductivity, which needs to be compensated by forming a nanocomposite with a conductive phase to allow the use of Li₈ZrO₆ as active material in an electrode.

The stability of the Li₈ZrO₆ structure during electrochemical cycling was examined by obtaining the X-ray powder pattern of cells that had been partially delithiated and re-lithiated. These experiments showed very little change in structural dimensions after partial delithiation of Li₈ZrO₆ to approximately Li_{7.62}ZrO₆ and subsequent relithiation, as shown in the powder XRD patterns obtained for Li₈ZrO₆/C composite electrodes (FIG. 5). Focusing on the characteristic (003), (101), and (012) peaks, no significant shift is observed during electrochemical cycling, confirming that the structure is maintained. A small peak appears at a d-spacing slightly larger than that of the (003) peak during the first cycle, potentially signifying a minute expansion of the layered structure in a fraction of the material. The very small volume changes during delithiation and relithiation should be beneficial for maintaining the integrity of the electrode material over multiple cycles.

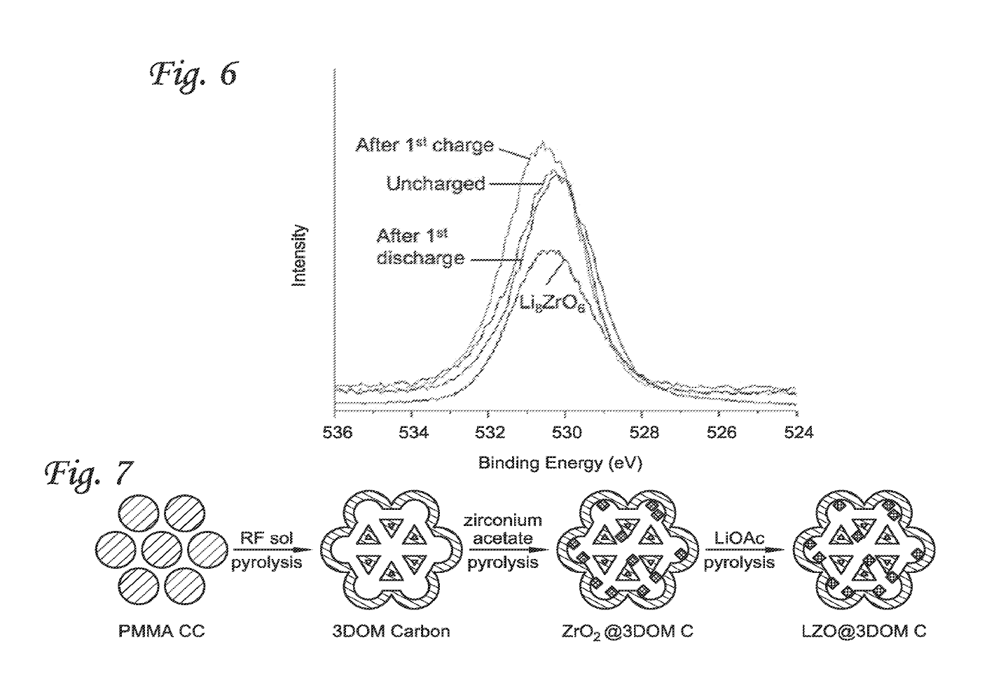

Because Li₈ZrO₆ does not contain a redox active metal, computational modeling indicated that the charges on oxygen become less negative when lithium is removed. The partial oxidation of oxygen atoms was experimentally observed by X-ray photoelectron spectroscopy (XPS) of a Li₈ZrO₆-containing cathode after delithiation (charging of the cell). The O₁ₛ peak shifts from 530.3 eV in the uncharged (lithiated) electrode to a slightly higher binding energy of 530.6 eV after charging (partial delithiation to ca. Li_{7.62}ZrO₆) and then returns to 530.2 eV after discharge (FIG. 6). The shift to higher binding energy can be associated with an increase in oxidation state of the oxygen as a result of the delithiation (Dai et al., Phys. Rev. B 1988, 38, 5091-5094; and Merino et al., Appl. Surf. Sci. 2006, 253, 1489-1493). It should be noted that the oxygen peak contains an envelope of oxygen contributions from both Li₈ZrO₆ and oxygen atoms from the PF-derived carbon phase in the composite cathode, so that the actual shift from partially delithiated Li₈ZrO₆ may in fact be slightly larger.

### Example 3

A nanocomposite, LZO@3DOM C, in which nanoparticles of LZO were confined within the macropores of 3DOM carbon, showed a discharge capacity of 62 mAh/g at 0.4 C after 10 cycles, showing an improvement compared to the bulk material with larger particle size. LZO is used as the abbreviation of Li₈ZrO₆ here.

Synthesis and Assembly of Monodisperse Poly(methyl methacrylate) (PMMA) Spheres. PMMA spheres with a diameter of 502±20 nm were synthesized by an emulsifier-free emulsion polymerization (Schroden et al., Journal of Materials Chemistry 2002, 12(11): 3261-3267). In a typical synthesis, 400 mL of methyl methacrylate (MMA) and 1590 mL of DI water were stirred at 300 rpm and bubbled with nitrogen to remove dissolved air while heating to 70° C. A solution of 1.0 g of potassium persulfate in 10 mL of DI water was added, and nitrogen was turned off. The mixture was left to react overnight. The resulting suspension was filtered through glass wool to remove big aggregates, transferred into a glass crystallization dish, and covered with aluminum foil. After slow sedimentation of the spheres and evaporation of waters, monoliths of PMMA colloidal crystal (CC) with a size of several millimeters were obtained.

Synthesis of LZO@3DOM C. The synthesis of LZO@3DOM C nanocomposites is summarized in FIG. 7. 3DOM carbon was first synthesized using PMMA CC as the template, followed by growth of ZrO₂ within the macropores, and further conversion of ZrO₂ into Li₈ZrO₆. The synthesis of 3DOM carbon was reported in the literature (Lee et al., Advanced Functional Materials 2005, 15(4):547-556). Briefly, 0.06 g of Na₂CO₃ and 3.4 g of resorcinol was dissolved in 4.5 mL of formaldehyde (37% aqueous). The solution obtained was infiltrated into PMMA CCs, and then cross-linked at 85° C. for 3 days. The product was pyrolyzed in N₂ at 900° C. for 2 hours with a ramp rate of 2° C./minute to produce 3DOM carbon. Chunks of 3DOM carbon were ground into sub-mm sized particles. A ZrO₂ precursor solution containing same mass of zirconium acetate solution (approximately 16% of Zr) and methanol, was repeatedly infiltrated into 3DOM carbon followed by drying at 60° C. in vacuum for 3 times, and the mass ratio of 3DOM carbon:ZrO₂ precursor solution was 1:2 for each infiltration. ZrO₂@3DOM C was obtained by pyrolyzing the infiltrated product in 600 sccm of N₂ at 900° C. for 4 hours with a ramp rate of 5° C./minute. ZrO₂@3DOM C was infiltrated with a solution of lithium acetate solution in methanol to reach a 14:1 Li:Zr molar ratio. After infiltration and drying, the product was pyrolyzed in N₂. The temperature was held at 600° C., 800° C., and 900° C. for 3 hours, 2 hours, and 4 hours, respectively, with a ramp rate of 2° C./minute.

Characterization. XRD patterns were collected with a PANalytical X'Pert PRO diffractometer using Co Kα(λ=1.79 Å). The crystallite size was calculated using the Scherrer equation. The sample morphology was imaged with a JEOL 6500 scanning electron microscope (SEM) with a 5-nm-thick Pt coating on each sample, or a FEI Technai T12 transmission electron microscope (TEM). The ZrO₂ content in the nanocomposites was determined by thermogravimetric analysis (TGA) using a Netzsch STA 409 analyzer. The samples were combusted in air with a ramp rate of 10° C./minute to 900° C. The carbon content in the nanocomposites of Li₈ZrO₆ and carbon was measured by flask combustion by Atlantic Microlab.

Electrochemical Testing. A slurry was made by grinding the nanocomposite LZO@3DOM C, Super P carbon black, and a 5% solution of Kynar PVDF in NMP together. The mass ratio of nanocomposite:carbon black:PVDF was 80:10:10. Since elemental analysis indicated that the LZO content in the nanocomposite was 75%, the electrode had an overall composition of 60:30:10 (LZO:carbon:PVDF). The slurry was cast onto a piece of carbon-coated aluminum film, and dried first under ambient conditions overnight, and then in vacuum at 120° C. for another day. CR 2032 coin cells were assembled using the film as the cathode, lithium foil as the anode, a Celgard 3501 membrane as the separator, and a commercial electrolyte 1 M LiPF₆ in a 1/1/1 mixture by volume of ethylene carbonate (EC), dimethyl carbonate (DMC), and diethyl carbonate (DEC). The cells were assembled in a glove box filled with helium, and cycled with an Arbin ABTS 4.0 tester in the potential range of 1.1-4.7 V. C was defined as one Li⁺ per Li₈ZrO₆, with a current density of 110.5 mA/g. Electrodes were also made from bulk LZO with the same composition, as a comparison to show the effect of nanosize on electrochemical performance.

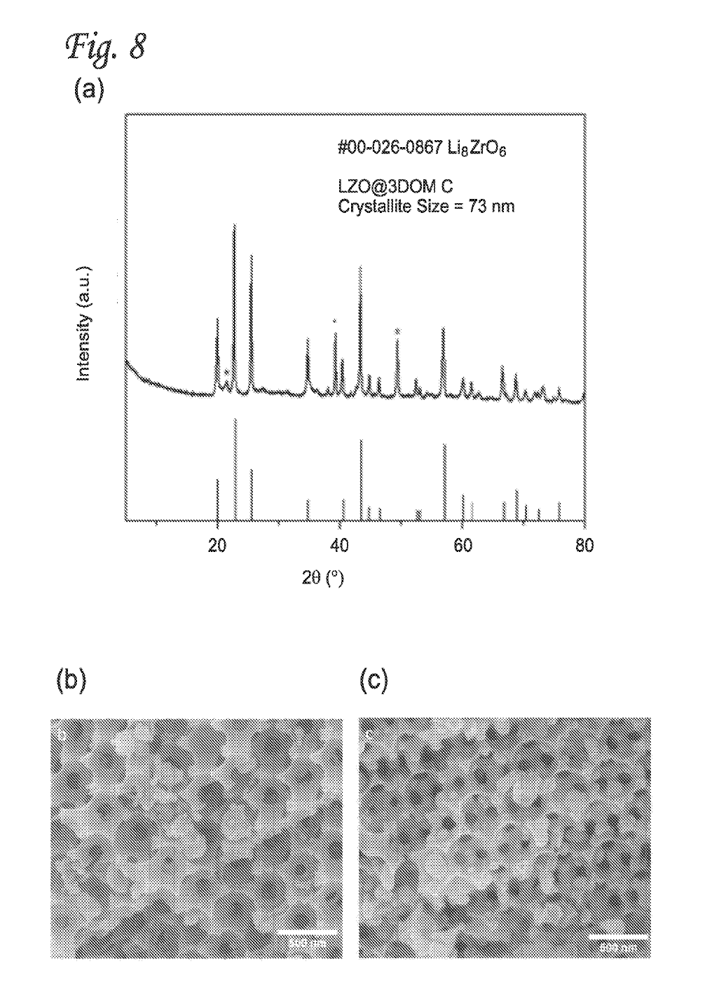

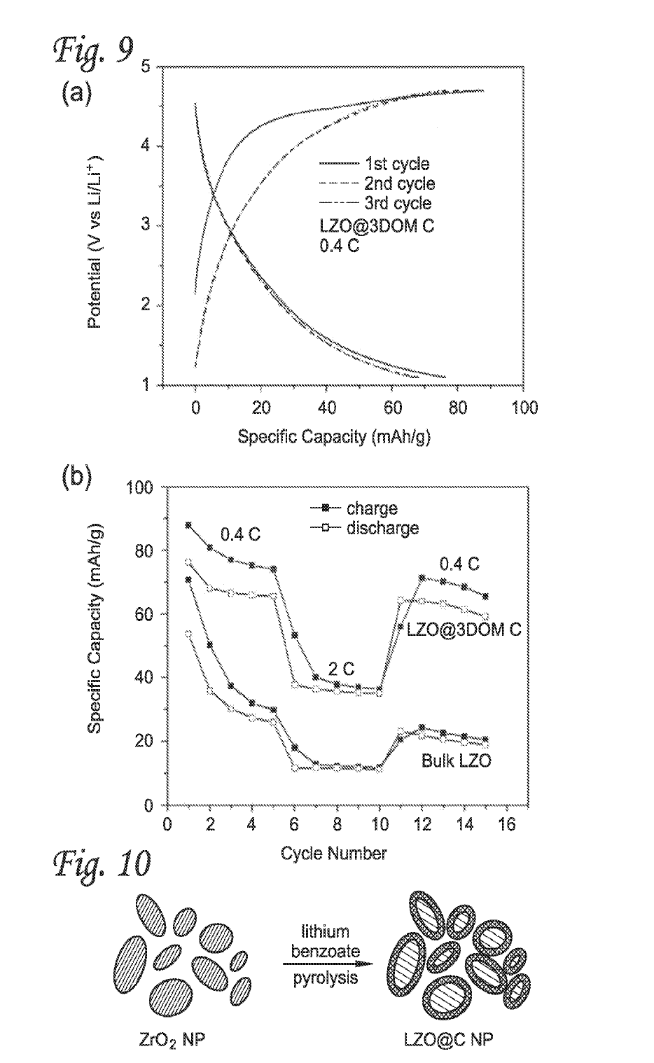

Results and Discussion. XRD (FIG. 8a) shows that Li₈ZrO₆ was the major product in LZO@3DOM C with Li₆Zr₂O₇ and Li₂O as impurities. Using the Scherrer equation, the average crystallite size of Li₈ZrO₆ in the composite was estimated to be 73 nm. SEM images (FIGS. 8b and 8c) revealed that in both ZrO₂@3DOM C and LZO@3DOM C, the interconnected ordered macroporous structure was well maintained, and nanoparticles of inorganic phases were confined within the macropores. The average particle size of Li₈ZrO₆ in LZO@3DOM C was 59±18 nm, matching with the XRD result. The nanosize of Li₈ZrO₆ here was a result of confinement in the pores of 3DOM structure, and was favored for its short length of electron conduction and ion diffusion, which was expected to provide better electrochemical performance than bulk material.

The electrochemical performance as a cathode material in lithium-ion batteries of LZO@3DOM C nanocomposite was compared with bulk material. As shown in FIG. 9, LZO@3DOM C had a capacity of ca. 70 mAh/g at 0.4 C and ca. 40 mAh/g at 2C, significantly higher than the bulk material. Since the electrodes of LZO@3DOM C and bulk LZO were of the same composition, such difference of capacity is ascribed to the different crystallite size.

It should also be addressed that at this capacity, only a small fraction of LZO was used in the electrochemical reaction. This was also indicated by the large overpotential, as shown in the charge and discharge curves (FIG. 9a). Smaller crystallite sizes and greater conductivity (e.g., through doping) are needed to achieve greater utilization of LZO.

### Example 4

Another nanocomposite, LZO@C NP, in which nanocrystallites of LZO was coated with carbon, had a capacity of ca. 40 mAh/g at C/5. LZO is used as the abbreviation of Li₈ZrO₆ here, and NP stands for nanoparticle.

Synthesis of LZO@C NP. ZrO₂ NP was synthesized by heating a solution of 1.288 g (4 mmol) of ZrOCl₂.8H₂O in 80 mL of dimethylformamide (DMF) to 110° C. for 36 hours (Zhang et al., Ceramics International 2014, 41 (Part A):2626-2630). The resulting gel was centrifuged and washed repeatedly with DMF once, with water three times, and then with ethanol twice. Finally the gel was dried at 70° C. overnight and 100° C. in vacuum for 2 hours to fully remove the solvent and produce ZrO₂ NP. The ZrO₂ NP was further ball-milled for 10 minutes with lithium benzoate, with a 12:1 Li:Zr molar ratio. The mixture was then pyrolyzed in N₂. The temperature was held at 600° C., 800° C., and 900° C. for 3 hours, 2 hours, and 4 hours, respectively, with a ramp rate of 2° C./minute. During the synthesis, the benzoate anion was converted into carbon, coating on the surface of LZO particles, as shown in FIG. 10.

Characterization and Electrochemical Testing. Characterization and cell fabrication was the same as for Example 3. The cells were cycled in the potential range of 1.3-4.5 V at C/5 and C.

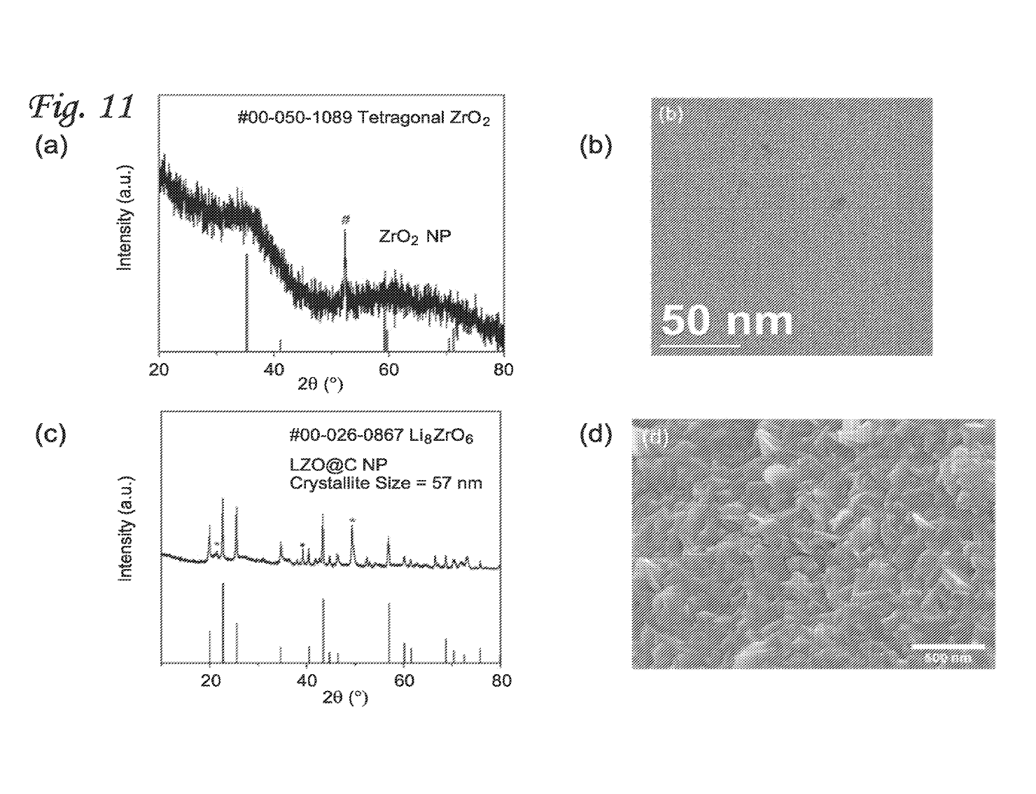

Results and Discussions. ZrO₂ NP was synthesized using the hydrolysis of ZrOCl₂.8H₂O in DMF. The very broad peaks from tetragonal ZrO₂ phase indicated the nanocrystalline nature of the sample (FIG. 11a). These nanoparticles with a size of a few nanometers can be clearly imaged by TEM (FIG. 11b). After reacting with lithium benzoate, Li₈ZrO₆ with a crystallite size of 57 nm was formed (FIG. 11c) as LZO@C NP, with some Li₆Zr₂O₇ and Li₂O as impurities. This sample had a Li₈ZrO₆ content of 77%, in other words, the 23% of carbon was the product of the pyrolysis of lithium benzoate. The carbon here acted as a barrier to limit the crystallite growth of LZO, leading to a nanocomposite. Under SEM, the surface of LZO@C NP was highly textured (FIG. 11d). The nanocomposite was composed of nanosheets in different orientations with a thickness of tens of nanometers.

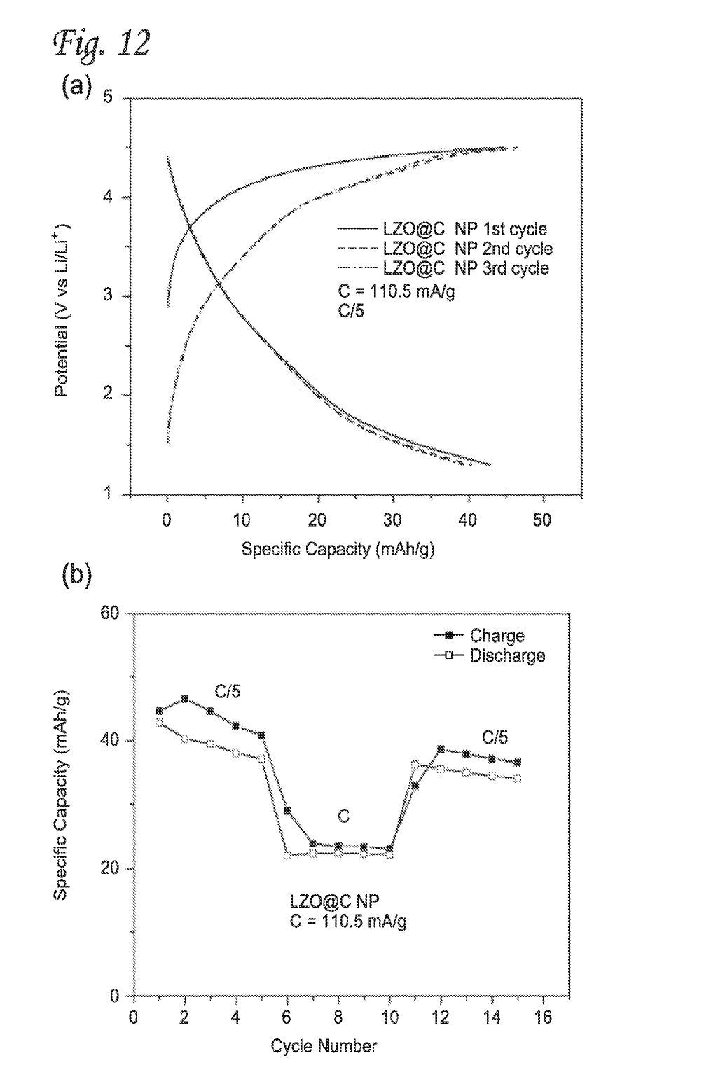

LZO@C NP had a capacity of ca. 40 mAh/g at C/5, and ca. 20 mAh/g at C when cycled between 1.3 V and 4.5 V, corresponding to extraction and insertion of 0.36 and 0.18 of lithium ion per unit formula, respectively. Similar to Example 3, it also exhibited a large overpotential due to its low conductivity (FIG. 12).

### Example 5

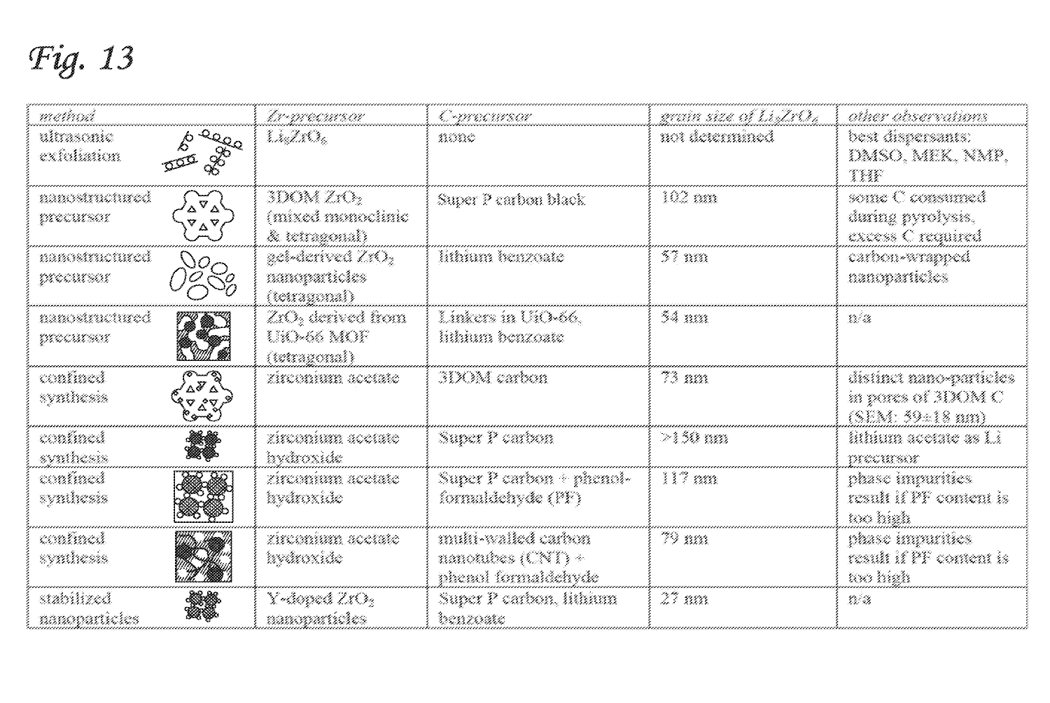

Other methods to reduce the crystallite size are included in this section. Multiple approaches were evaluated to reduce the grain size of Li₈ZrO₆ particles to shorten diffusion paths through active material and increase electrochemical utilization, including methods designed to incorporate a conductive carbon phase with active material directly during the synthesis to physically impede grain growth while creating an intimate contact with active material. These approaches include ultrasonic exfoliation of layers in presynthesized Li₈ZrO₆, synthesis from nanostructured precursors (three-dimensionally ordered macroporous (3DOM) ZrO₂, ZrO₂ nanoparticles derived from the Zr-containing metal organic framework (MOF) UiO-66), and synthesis in confinement of carbon phases (Super P carbon, multi-walled carbon nanotubes, resol-derived carbon). Precursor selection impacted control of grain size and phase purity of Li₈ZrO₆ and the effective carbon content/distribution in the nanocomposite phase. For example, in the synthesis of Li₈ZrO₆ from ZrO₂ precursors, Li incorporation can be carried out by reaction with lithium acetate or lithium benzoate; the latter achieves a higher content of conductive carbon in the product. In the UiO-66 based synthesis, the MOF provides both Zr and C, with additional carbon added after reaction with lithium benzoate and pyrolysis. All of these syntheses were optimized to maximize the phase purity of Li₈ZrO₆ (i.e., minimize impurity phases such as Li₆Zr₂O₇ or Li₂O) and minimize grain size as determined by Scherrer broadening of XRD lines. We observed that carbon limited grain growth of Li₈ZrO₆ in several of these materials. FIG. 13 summarizes the grain size reduction methods (including those used in Example 1-4), indicating precursors, smallest grain sizes achieved to-date and other relevant observations.

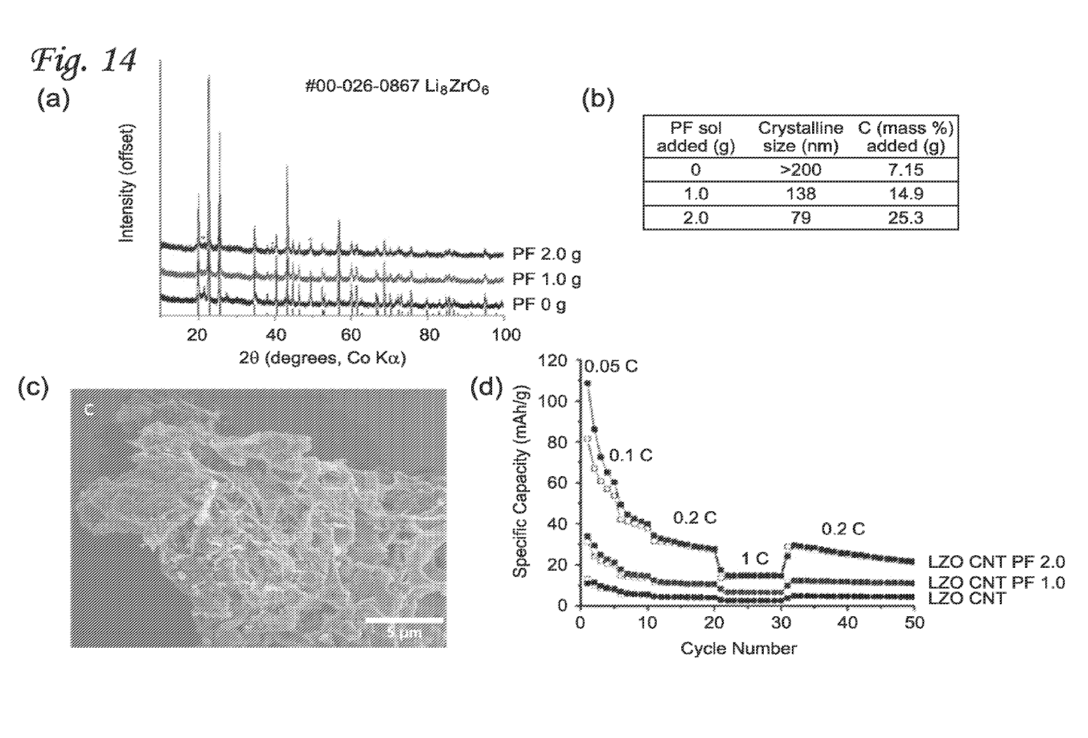

Examples of effects of grain size on specific capacity of Li₈ZrO₆ are shown in FIG. 14. The sample shown here was synthesized by reacting zirconium acetate hydroxide and lithium acetate with the presence of carbon nanotubes (CNTs) and phenol-formaldehyde (PF) resol. The major phase in the product was Li₈ZrO₆ according to XRD (FIG. 14a). A typical SEM image was shown in FIG. 14b, exhibiting a “framework” morphology composed of nanoparticles and CNTs. We observed that as more PF resol was added, higher content of carbon in the final product and smaller crystallite sizes of Li₈ZrO₆ was obtained, which further increased capacities (FIGS. 14c and 14d). Using these data, we deduced that with our current particle sizes only a small portion of Li₈ZrO₆ was utilized and estimated that approximately 5 to 20 nm crystallites may be useful for full utilization. We achieved the highest utilization at this point with Y-doped Li₈ZrO₆ with 42 nm particles (as shown in Example 1).

### Example 6

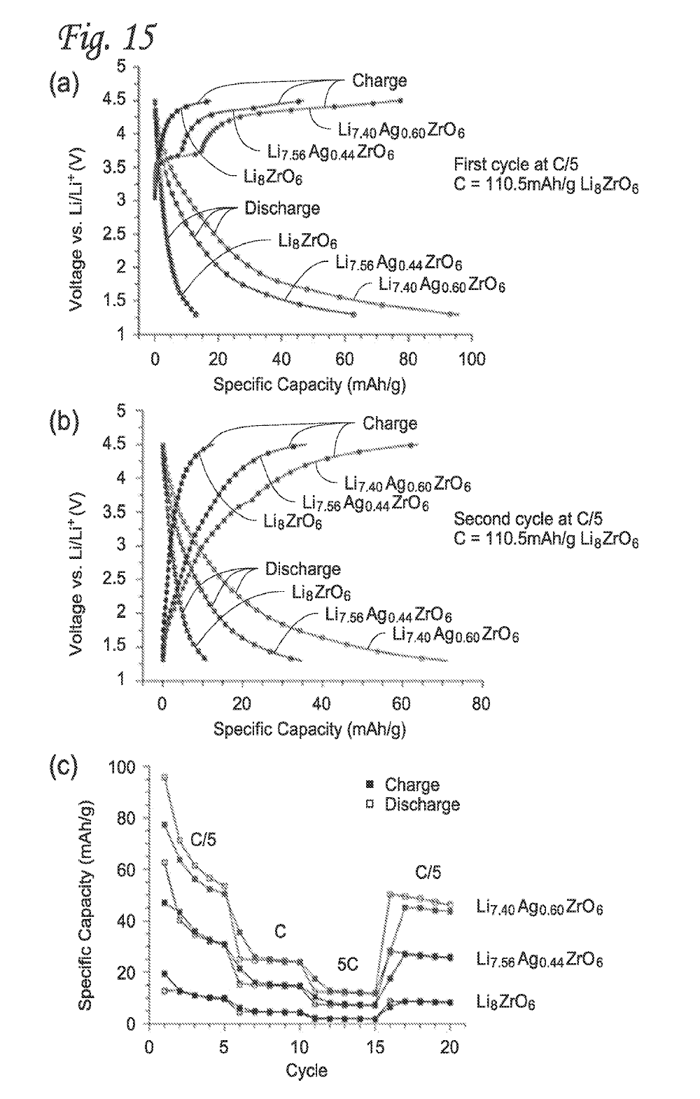

Doping of Li₈ZrO₆. With the ultimate goals to increase the electronic and ionic conductivities of Li₈ZrO₆, lower its overpotential, and reduce particle size, we have investigated methods of doping Li₈ZrO₆ with ions that substitute either for lithium sizes or for zirconium sites, using computations to guide experimental studies. We studied substitutions with Mg and Nb (to create Li⁺ vacancies), Y (to reduce grain size), Ag (to increase electronic conductivity), and Ti and Ce (both to decrease bandgap and increase conductivity). Depending on the ion, the ion was introduced either through direct incorporation during the synthesis or through solution or melt exchange in pre-formed Li₈ZrO₆. In all cases, synthesis conditions were optimized to maintain the layered structure of the Li₈ZrO₆ parent and to minimize secondary phases (especially Li₆Zr₂O₇, Li₂O) as much as possible. We compared the experimental XRD patterns and simulated results, and the trends agree well. Doping with Mg and Nb decreases the volume of the unit cell, and doping with Ag and Ce increases the volume of unit cell slightly. At a doping level of 1 Ti or Mg/unit cell, XRD peaks of Li₂O and Li₄TiO₄ or MgO were observed; however Nb and Ce formed solid solutions at these levels. A substantial increase in discharge capacity was observed for Ag⁺ ion-exchanged Li₈ZrO₆ (bulk material, not size-reduced) compared to bulk Li₈ZrO₆ (FIG. 15).

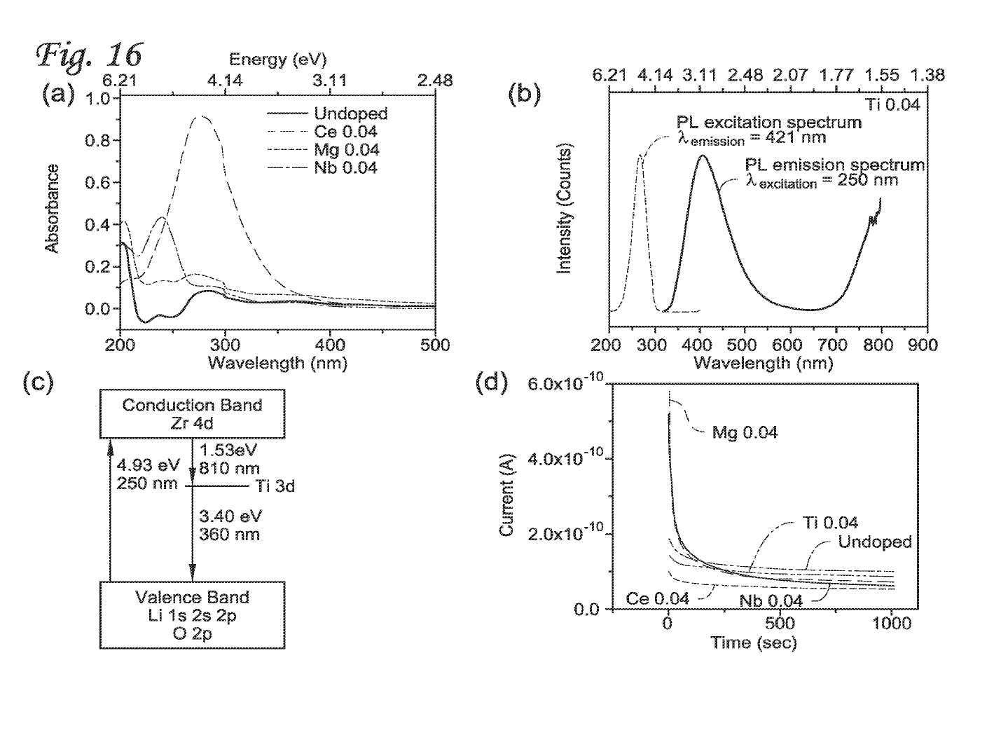

The effects of doping on band structures of Li₈ZrO₆ were characterized by UV-vis spectroscopy, using low doping levels of 0.04/formula unit to ensure phase purity. On the basis of its UV-vis spectrum, undoped Li₈ZrO₆ has a band gap of ca. 5.75 eV (FIG. 16a). While Mg doping has almost no effect on the UV-vis spectrum, both Nb and Ce doping cause redshifts of the UV-vis absorbance, indicating decreases in band gap energies, consistent with computational results. Ti 0.04 was photoluminescent. The corresponding photoluminescence spectra provided details about its band structure (FIG. 16b). The excitation peak at 267 nm corresponded to the transition from valence band to the conduction band. In the emission spectrum, two peaks, one at 402 nm and the other out of the wavelength range of the instrument, corresponded to the transition from the dopant states to the valence band, and from the conduction band to dopant states, respectively. The energy values of these peaks corresponded well with the computational band diagram of Ti-doped Li₈ZrO₆, as shown in FIG. 16c. On the basis of dc measurements using pellets of bulk materials (FIG. 16d), ionic conductivity was improved by an order of magnitude by Nb and Mg doping, because of the introduction of Li⁺ vacancies. Although Nb and Ti doping changed the band structure of Li₈ZrO₆, there was almost no change in electronic conductivity. The charge carrier level of this material may be determined extrinsically.

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

1. A composite material comprising domains of one or more lithium oxometallates in an electronically conductive matrix, wherein the one or more lithium oxometallates are of the formula Li₈M^{a}O₆, Li₇M^{b}O₆, or a doped lithium oxometallate thereof, wherein Ma represents Zr and/or Sn, and M^{b} represents Nb and/or Ta.

2. The composite material of claim 1 wherein the doped lithium oxometallate of the formula Li₈M^{a}O₆ further comprises a lithium replacing dopant and is of the formula Li₍₈₋ₙₓ₎DₓM^{a}O₆, wherein M^{a} represents Zr and/or Sn; D represents an optional lithium replacing dopant selected from the group consisting of Mg, Ag, Co, Ni, or a combination thereof; n represents the formal oxidation state of the dopant D; and x=0.00005 to 2.

3. The composite material of claim 1 wherein the doped lithium oxometallate of the formula Li₈M^{a}O₆ further comprises:
a Li and M^{a} replacing dopant, wherein the doped lithium oxometallate is of the formula Li₍₈₋ₓ₍ₙ₋₄₎₎EₓM^{a}₍₁₋ₓ₎O₆, wherein M^{a} represents Zr and/or Sn; E represents a Li and M^{a} replacing dopant selected from the group consisting of Ti, Nb, Ce, Mo, Y, Mn, Fe, or a combination thereof; n represents the formal oxidation state of the dopant E; and x=0.00005 to 0.25;
an M^{a} and O replacing dopant, wherein the doped lithium oxometallate is of the formula Li₈EₓM^{a}₍₁₋ₓ₎O_{(6+(n-4)x/2)}, wherein M^{a} represents Zr and/or Sn; E represents an M^{a} and O replacing dopant selected from the group consisting of Ti, Nb, Ce, Mo, Y, Mn, Fe, or a combination thereof; n represents the formal oxidation state of the dopant E; and x=0.00005 to 0.25; or
a Li, M^{a}, and O replacing dopant, wherein the composition of the doped lithium oxometallate corresponds to a combination of the formulas Li₍₈₋ₓ₍ₙ₋₄₎₎EₓM^{a}₍₁₋ₓ₎O₆ and Li₈EₓM^{a}₍₁₋ₓ₎O_{(6+(n-4)x/2)}, wherein M^{a} represents Zr and/or Sn; E represents a Li, M^{a}, and O replacing dopant selected from the group consisting of Ti, Nb, Ce, Mo, Y, Mn, Fe, or a combination thereof; n represents the formal oxidation state of the dopant E; and x=0.00005 to 0.25.

4. The composite material of claim 1 wherein the doped lithium oxometallate of the formula Li₇M^{b}O₆ further comprises a lithium replacing dopant and is of the formula Li₍₇₋ₙₓ₎DₓM^{b}O₆, wherein M^{b} represents Nb and/or Ta; D represents an optional lithium replacing dopant selected from the group consisting of Mg, Ag, Co, Ni, or a combination thereof; n represents the formal oxidation state of the dopant D; and x=0.00005 to 2.

5. The composite material of claim 1 wherein the doped lithium oxometallate of the formula Li₇M^{b}O₆ further comprises:
a Li and M^{b} replacing dopant, wherein the doped lithium oxometallate is of the formula Li₍₇₋ₓ₍ₙ₋₅₎₎EₓM^{b}₍₁₋ₓ₎O₆, wherein M^{b} represents Nb and/or Ta; E represents a Li and M^{b} replacing dopant selected from the group consisting of Ti, Nb, Ce, Mo, Y, Mn, Fe or a combination thereof; n represents the formal oxidation state of the dopant E; and x=0.00005 to 0.25;
an M^{b} and O replacing dopant, wherein the doped lithium oxometallate is of the formula Li₇EₓM^{b}₍₁₋ₓ₎O_{(6+(n-5)x/2)}, wherein M^{b} represents Nb and/or Ta; E represents an M^{b} and O replacing dopant selected from the group consisting of Ti, Nb, Ce, Mo, Y, Mn, Fe, or a combination thereof; n represents the formal oxidation state of the dopant E; and x=0.00005 to 0.25; or
a Li, M^{b}, and O replacing dopant, wherein the composition of the doped lithium oxometallate corresponds to a combination of the formulas Li₍₇₋ₓ₍ₙ₋₅₎₎EₓM^{b}₍₁₋ₓ₎O₆ and Li₇EₓM^{b}₍₁₋ₓ₎O_{(6+(n-5)x/2)}, wherein M^{b} represents Nb and/or Ta; E represents a Li, M^{b}, and O replacing dopant selected from the group consisting of Ti, Nb, Ce, Mo, Y, Mn, Fe, or a combination thereof; n represents the formal oxidation state of the dopant E; and x=0.00005 to 0.25.

6-7. (canceled)

8. The composite material of claim 1 wherein the domains of the one or more doped or undoped lithium oxometallates comprise nanoparticles and/or nanosheets of the one or more lithium oxometallates.

9. The composite material of claim 1 wherein the electronically conductive matrix comprises conductive carbon and/or conductive metallic nanoparticles.

10-12. (canceled)

13. A lithium ion battery comprising a composite material according to claim 1.

14-17. (canceled)

18. A method of making a composite material, the method comprising:
adding LiX and optionally sources for optional dopants D and/or E in an optional solvent into a 3-dimensionally ordered macroporous (3DOM), nanoparticles, or nanocomposites of doped or undoped M^{a}O₂ , M^{b}O₂, M^{a}O₂/C, M^{b}O₂/C, M^{a}O₂@3DOM C, or M^{b}O₂@3DOM C material; wherein Ma represents Zr and/or Sn; M^{b} represents Nb and/or Ta; D represents an optional dopant selected from the group consisting of Mg, Ag, Co, Ni, or a combination thereof; E represents an optional dopant selected from the group consisting of Ti, Nb, Ce, Mo, Y, Mn, Fe, or a combination thereof; and wherein X⁻ is an organic or inorganic anionic species;
optionally drying the infiltrated material to remove at least a portion of the optional solvent; and
pyrolyzing the optionally dried infiltrated material.

19. The method of claim 18 wherein the anionic species X⁻ is selected from the group consisting of hydroxide, acetate, acetylacetonate, fluoride, chloride, bromide, iodide, nitrate, perchlorate, sulfate, tetrafluoroborate, hexafluorophosphate, alkoxide, carbonate, borohydride, hydride, a carboxylate, phenoxide, naphthalate, imides optionally containing one or more aromatic rings, and combinations thereof.

20. The method of claim 18 further comprising grinding the composite material to form nanoparticles.

21. The method of claim 18 wherein pyrolyzing comprises heating at temperatures of 500° C. to 1000° C. for 1 to 12 hours.

22. (canceled)

23. The method of claim 18 wherein pyrolyzing comprises heating in nitrogen and/or argon.

24. A method of making a composite material, the method comprising:
providing a slurry of conductive particles and one or more doped or undoped lithium oxometallates in a solvent; and
drying the slurry to form the composite material,
wherein the one or more doped or undoped lithium oxometallates are of the formula Li₈M^{a}O₆, Li₇M^{b}O₆, or a doped lithium oxometallate thereof, wherein M^{a} represents Zr and/or Sn, and M^{b} represents Nb and/or Ta.

25. The method of claim 24 further comprising delaminating sheets of the composite material.

26. The method of claim 24 wherein the conductive particles comprise conductive carbon and/or conductive metallic nanoparticles.

27. The method of claim 24 wherein the slurry further comprises a polymeric binder.

28. The method of claim 27 wherein the polymeric binder is selected from the group consisting of polyacrylic acid (PAA), poly(vinyldiene fluoride) (PVDF), sodium carboxymethyl cellulose (CMC), alginate, poly(methyl methacrylate) (PMMA), poly(vinylidenefluoride-co-hexafluoropropylene) (PVDF-HFP), CMC/styrene butadiene rubber (SBR), styrene-butadiene rubber (SBR), polytetrafluoroethylene (PTFE), carboxymethyl cellulose (CMC), water-based aqueous binders, and combinations thereof.

29. The method of claim 24 wherein the solvent is selected from the group consisting of water, N-methyl 2-pyrrolidone, tetrahydrofuran, acetone, 1,2-dichlorobenzene, 2-butanone, dimethyl sulfoxide, 2-chlorophenol, and combinations thereof.

30. The method of claim 24 wherein the slurry is applied to a support, and drying forms a film of the composite material.
